(19) United States
(12) Patent Application Publication
(10) Pub. No.: US 2026/0119247 A1
(43) Pub. Date: Apr. 30, 2026

(54) COMPUTATION ACCELERATOR FOR DEEP NEURAL NETWORK AND ITS OPERATION METHOD

(71) Applicants: SEOUL NATIONAL UNIVERSITY R&DB FOUNDATION, Seoul (KR); SOGANG UNIVERSITY RESEARCH & BUSINESS DEVELOPMENT FOUNDATION, Seoul (KR)

(72) Inventors: Jae-Joon KIM, Seoul (KR); Hyunsung YOON, Seoul (KR); Sungju RYU, Seoul (KR)

(21) Appl. No.: 19/003,422

(22) Filed: Dec. 27, 2024

(30) Foreign Application Priority Data
Dec. 29, 2023 (KR) 10-2023-0196617
Jun. 20, 2024 (KR) 10-2024-0080015

(51) Int. Cl. G06F 9/50; G06F 9/54

(52) U.S. Cl. CPC G06F 9/5027; G06F 9/544; G06F 2209/5017; G06F 2209/543

(57) ABSTRACT

A computation accelerator according to an embodiment includes: a global buffer in which first data or second data is temporarily stored in the form of a dense matrix or in the form of a compressed sparse matrix; a first decompression unit that decompresses the first data when the first data output by the global buffer is in the form of the compressed sparse matrix; a second decompression unit that decompresses the second data when the second data output by the global buffer is in the form of the compressed sparse matrix; and a computation unit that performs computation on the first and second data received in the form of the dense matrix from the global buffer or the first and second data decompressed in the form of the dense matrix by the first and second decompression unit.

### CROSS-REFERENCE TO RELATED APPLICATION

This application claims the benefit under 35 USC 119(a) of Korean Patent Application Nos. 10-2024-0080015 filed on Jun. 20, 2024 and 10-2023-0196617 filed on Dec. 29, 2023 in the Korean Intellectual Property Office, the entire disclosures of which are incorporated herein by reference for all purposes.

### TECHNICAL FIELD

The present disclosure relates to a computation accelerator for a deep neural network and its operation method.

### BACKGROUND

Recently, the application range of artificial intelligence (AI) has been expanded and the accuracy thereof has been continuously improved. The advancements in AI technology can largely be attributed to the increased number of layers constituting an AI system and parameters within those layers. However, this means that the amount of data required for computations of the AI system grows, which leads to an increase in energy consumption caused by an increase in the number of computations as well as an increase in time and energy required to transfer and store data between a data storage device and a computation accelerator.

Further, if the amount of data required for computations of the AI system exceeds the amount of data to be stored in the accelerator, the accelerator needs to repeatedly exchange data with an external storage device, such as DRAM. Communication with the external storage device consumes more time and energy than communication with an internal storage device in the accelerator, which causes a reduction in efficiency of the AI accelerator.

Various methods have been proposed to mitigate the effects of increased parameters while maintaining the performance of the AI system. One well-known method is data compression, such as weight pruning. Weight pruning prunes weights with values, which are deemed small, insignificant and close to zero (0), by setting these weights to 0. Therefore, skipping computations involving 0 can reduce the overall computation load, and adopting a compressed data format can alleviate the burden associated with data communication and storage.

In general, a compression format stores only values of non-zero elements from original data to take advantage of the benefits of sparse data. For example, CSC (Compressed Sparse Column), as a representative compression format, stores values of non-zero elements in a column direction. Herein, the stored values consist of a value of a non-zero element itself, an index representing a row of the value in a weight matrix, and a column pointer that accumulates the number of non-zero elements in each column. The CSC that selectively stores only the necessary information stores a smaller amount of information than a compression format that stores information of all values. Thus, the CSC can significantly reduce the complexity of processing sparse neural networks.

While data compression offers benefits in terms of data storage and transfer, a specialized accelerator is required to maximize these benefits. Conventional accelerators specialized for dense matrix multiplication are designed for processing data stored in sequential order. However, the compressed data format stores data in non-sequential order as described above, and indirectly stores their original coordinates. Therefore, when the AI system performs matrix multiplication as a fundamental operation, it becomes necessary to identify the original coordinates of compressed data and determine pairs of data to be multiplied based on the coordinates.

Reflecting these needs, various accelerators have been developed to efficiently process sparse neural networks.

FIG. 1A and FIG. 1B illustrate configurations of commonly used AI accelerators.

FIG. 1A illustrates the structure of a dense neural network accelerator designed to perform dense matrix multiplication, while FIG. 1B illustrates the structure of a sparse neural network accelerator designed to perform sparse matrix multiplication.

The dense neural network accelerator shown in FIG. 1A reads data in a predetermined pattern and operates uniformly. Therefore, each processing element (PE) that performs computation includes only a minimum number of buffers and calculators required for computation, which results in reduced energy consumption for computation and a smaller design area. However, this structure, due to its uniform operation pattern, is not suitable for processing compressed data with irregular features and thus cannot take advantage of the benefits of sparse neural networks.

Each PE in the sparse neural network accelerator shown in FIG. 1B includes an index-matching device to identify data pairs to be computed by using their original coordinates. The number of computations performed by each PE is determined by the number of data pairs. When a large amount of data is processed to find data pairs, the likelihood of small variation in the number of data pairs to be processed by each PE increases. Thus, large buffers are used to store a large amount of data. Due to the effects of these additional devices, the PEs in the sparse neural network accelerator require a greater area than those in the dense neural network accelerator. Further, unnecessarily additional energy consumption occurs such as storing a large amount of data in buffers and performing multiplication and addition while searching for data pairs.

Since sparse neural network accelerators are specialized for irregular data processing, their performance varies depending on the sparsity of the neural network. Referring to the sparsity distribution of real-world sparse neural networks, data in some layers exhibits sparsity close to a sparsity level 0. Therefore, in a compression format, a greater storage capacity may be needed. This means that inefficiencies occur when the sparse neural network accelerator processes the entire network and consistent performance regardless of the characteristics of individual layers of the network is needed in order to efficiently process the entire sparse neural network.

To address these issues, the present disclosure proposes a computation accelerator that can efficiently process a sparse neural network stored in a compression format while utilizing a conventional dense neural network accelerator having a simple structure.

Related prior art documents include Korean Patent No. 10-2649482 (entitled “Neural Processing Accelerator”)

### SUMMARY

In view of the foregoing, the present disclosure is conceived to provide a computation accelerator that can process sparse matrix data stored in a compression format while using a dense matrix multiplication-only calculator, and its operation method.

The problems to be solved by the present disclosure are not limited to the above-described problems. There may be other problems to be solved by the present disclosure.

An aspect of the present disclosure provides a computation accelerator, including: a global buffer in which first data or second data is temporarily stored in the form of a dense matrix or in the form of a compressed sparse matrix; a first decompression unit that decompresses the first data when the first data output by the global buffer is in the form of the compressed sparse matrix; a second decompression unit that decompresses the second data when the second data output by the global buffer is in the form of the compressed sparse matrix; and a computation unit that performs computation on the first data received in the form of the dense matrix from the global buffer or the first data decompressed in the form of the dense matrix by the first decompression unit and the second data received in the form of the dense matrix from the global buffer or the second data decompressed in the form of the dense matrix by the second decompression unit.

Another aspect of the present disclosure provides an operation method of a computation accelerator, including: a process (a) of decompressing first data by a first decompression unit and then transferring the decompressed first data to a computation unit when the first data output by a global buffer is in the form of a compressed sparse matrix, or transferring the first data to the computation unit when the first data is in the form of a dense matrix; a process (b) of decompressing second data by a second decompression unit and then transferring the decompressed second data to the computation unit when the second data output by the global buffer is in the form of the compressed sparse matrix, or transferring the second data to the computation unit when the second data is in the form of the dense matrix; and a process (c) of performing computation on the first data received in the form of the dense matrix from the global buffer or the first data decompressed in the form of the dense matrix by the first decompression unit and the second data received in the form of the dense matrix from the global buffer or the second data decompressed in the form of the dense matrix by the second decompression unit.

According to an embodiment of the present disclosure, a processing unit having a simple structure designed to process dense matrix data is used to perform dense matrix multiplication on compressed matrix data. In particular, a global buffer only needs to store necessary data in a compression format, and, thus, it is possible to reduce the energy consumed for data storage in the global buffer. Further, a computation unit is configured with the processing unit having a simple structure designed to process dense matrix data, and, thus, it is possible to reduce the area required to design an accelerator. Furthermore, the accelerator processes data in a predetermined order and thus does not require devices for index matching. Therefore, it is possible to reduce the additionally required area and the energy required to perform computation.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different FIG.s indicates similar or identical items.

FIG. 1A and FIG. 1B illustrate configurations of commonly used AI accelerators.

FIG. 2, FIG. 3A and FIG. 3B illustrate configurations of a computation accelerator according to an embodiment of the present disclosure.

FIG. 4 illustrates a decompression process of the computation accelerator according to an embodiment of the present disclosure.

FIG. 5 is a flowchart showing an operation method of the computation accelerator according to an embodiment of the present disclosure.

FIG. 6 is a flowchart showing a decompression method of the computation accelerator according to an embodiment of the present disclosure.

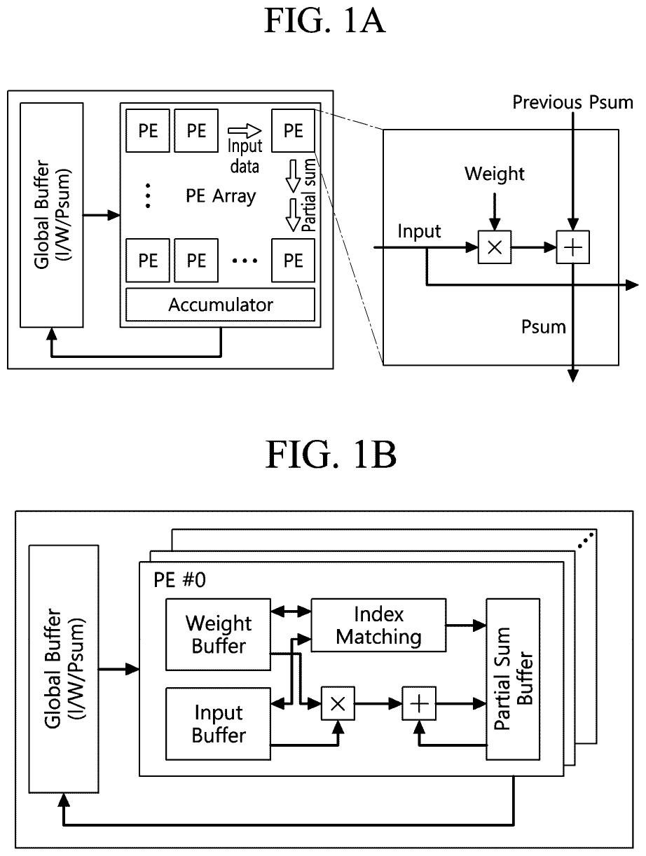

### DETAILED DESCRIPTION

Hereafter, embodiments will be described in detail with reference to the accompanying drawings so that the present disclosure may be readily implemented by a person with ordinary skill in the art. However, it is to be noted that the present disclosure is not limited to the embodiments but can be embodied in various other ways. In the drawings, parts irrelevant to the description are omitted for the simplicity of explanation, and like reference numerals denote like parts throughout the whole document.

Throughout this document, the term “connected to” may be used to designate a connection or coupling of one element to another element and includes both an element being “directly connected to” another element and an element being “electronically connected to” another element via another element. Further, throughout the whole document, the term “comprises or includes” and/or “comprising or including” used in the document means that one or more other components, steps, operation and/or existence or addition of elements are not excluded in addition to the described components, steps, operation and/or elements unless context dictates otherwise.

Throughout the whole document, the term “unit” includes a unit implemented by hardware or software and a unit implemented by both of them. One unit may be implemented by two or more pieces of hardware, and two or more units may be implemented by one piece of hardware. However, the “unit” is not limited to the software or the hardware and may be stored in an addressable storage medium or may be configured to implement one or more processors. Accordingly, the “unit” may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and functions provided by the “unit” may be either combined into a smaller number of components and “units” or divided into a larger number of components and “units”. Moreover, the components and “units” may be implemented to reproduce one or more CPUs within a device.

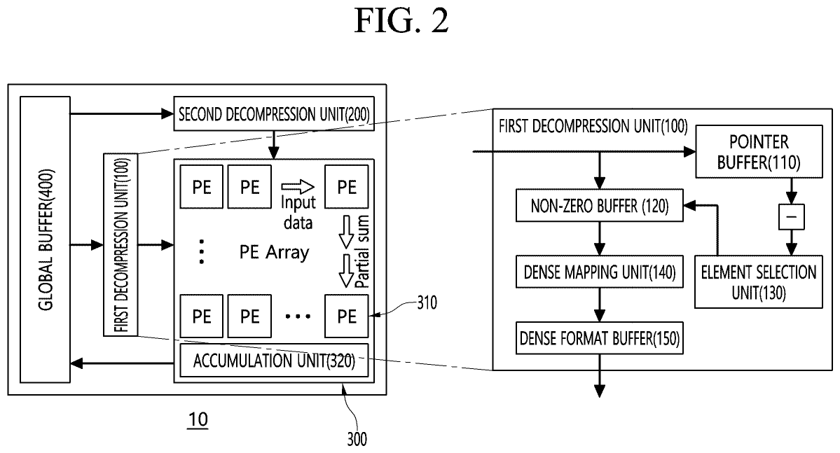

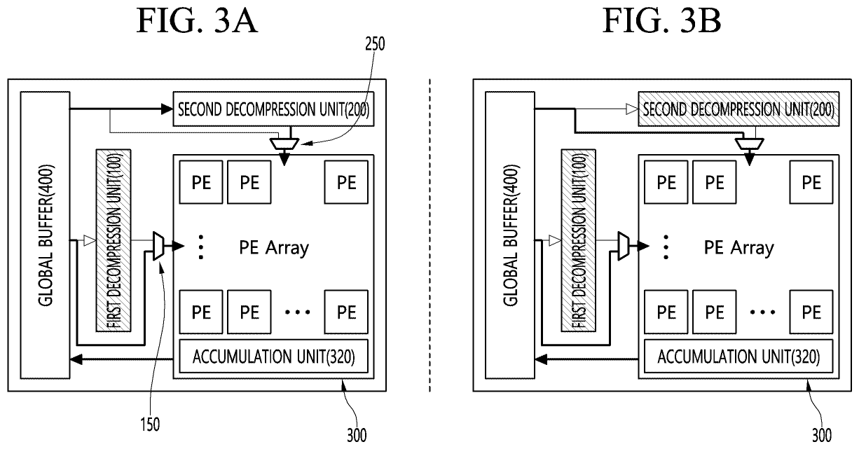

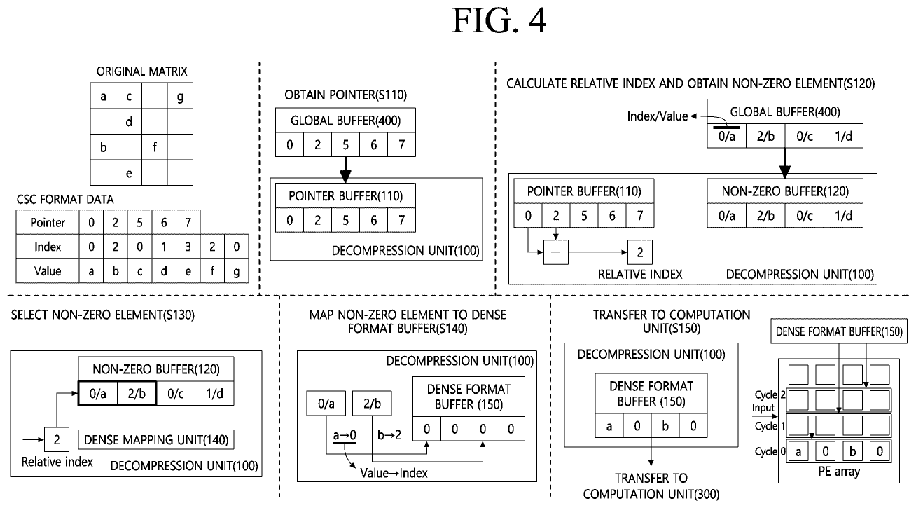

FIG. 2, FIG. 3A and FIG. 3B illustrate configurations of a computation accelerator according to an embodiment of the present disclosure, and FIG. 4 illustrates a decompression process of the computation accelerator according to an embodiment of the present disclosure.

A computation accelerator 10 includes a first decompression unit 100, a second decompression unit 200, a computation unit 300, and a global buffer 400.

The global buffer 400 stores input data and weight data received from an external device or external memory. The input data may be an activation value output from a previous layer among layers constituting a learning model and transferred to a next layer. The weight data may include a weight multiplied to the activation value or a weight used in a perceptron simulating the neurons. Herein, the global buffer 400 temporarily stores the input data or weight data in the form of a dense matrix or a compressed sparse matrix. In this case, CSC or CSR (Compressed Sparse Row) may be used as a compression format.

The first decompression unit 100 serves to decompress the input data output by the global buffer 400 when the input data is in the form of a compressed sparse matrix. Also, the second decompression unit 200 serves to decompress the weight data output by the global buffer 400 when the weight data is in the form of the compressed sparse matrix. Each of the decompression units 100 and 200 decompresses data compressed in the CSC or CSR format and transfers the decompressed data to the computation unit 300.

Further, the computation accelerator 10 may include a first multiplexer (MUX) 150 that selectively transfers either an output of the global buffer 400 or an output of the first decompression unit 100 to the computation unit 300, and a second MUX 250 that selectively transfers either an output of the global buffer 400 or an output of the second decompression unit 200 to the computation unit 300.

The first MUX 150 selects the output of the global buffer 400 and outputs the selected output to the computation unit 300 when the input data is in the form of a dense matrix. Also, the first MUX 150 selects the output of the first decompression unit 100 and outputs the selected output to the computation unit 300 when the input data is in the form of a compressed sparse matrix. Similarly, the second MUX 250 selects the output of the global buffer 400 and outputs the selected output to the computation unit 300 when the weight data is in the form of the dense matrix. Also, the second MUX 250 selects the output of the second decompression unit 200 and outputs the selected output to the computation unit 300 when the weight data is in the form of the compressed sparse matrix.

For example, as shown in FIG. 3B, when both the input data and the weight data are in the form of the dense matrix, the first MUX 150 and the second MUX 250 select the global buffer 400, allow the input data and the weight data to bypass the first decompression unit 100 and the second decompression unit 200, and directly transfer the input data and the weight data to the computation unit 300. However, when the input data is in the form of the dense matrix and the weight data is in the form of the compressed sparse matrix, the weight data passes through the second decompression unit 200 and the input data bypasses the first decompression unit 100 as shown in FIG. 3A. When the input data is in the form of the compressed sparse matrix and the weight data is in the form of the dense matrix, the input data passes through the first decompression unit 100 and the weight data bypasses the second decompression unit 200. Through this operation, the input data in the form of the dense matrix and the weight data in the form of the dense matrix are transferred to the computation unit 300.

The computation unit 300 includes a plurality of processing units (PEs) 310 and an accumulation unit 320. The plurality of PEs 310 is provided in the form of an array, for example, a systolic array. The computation unit 300 performs computation on input data received in the form of a dense matrix from the global buffer 400 or input data decompressed in the form of the dense matrix by the first decompression unit 100 and weight data received in the form of the dense matrix from the global buffer 400 or weight data decompressed in the form of the dense matrix by the second decompression unit 200. Thus, the computation unit 300 of the present disclosure is configured with the PEs 310 that perform computation on data in the form of the dense matrix.

Each PE 310 performs multiplication on input data and weight data received from external sources and then adds a partial sum output by a previous PE 310 and transfers the result to a next PE 310. The accumulation unit 320 receives and accumulates outputs of respective Pes, transfers the result to the global buffer 400, and allows the result to be output to an external memory or external device.

Hereafter, detailed configurations of the first decompression unit 100 and the second decompression unit 200 will be described. Since the first decompression unit 100 and the second decompression unit 200 have substantially the same configuration except target data to be decompressed, a detailed configuration of the first decompression unit 100 will be described.

The first decompression unit 100 may include a pointer buffer 110, a non-zero buffer 120, an element selection unit 130, a dense mapping unit 140, and a dense format buffer 150.

A detailed configuration and operation method of the first decompression unit 100 will be described with reference to FIG. 2 and FIG. 4.

First, original matrix data before compression and compressed sparse matrix data will be described. As shown in the drawings, the original matrix data may be dense matrix data including values of at least one non-zero element recorded according to a general matrix.

As shown in the drawings, it is assumed that as for the original matrix data, a and b are stored in a first column, c, d, and e are stored in a second column, f is stored in a third column, and g is stored in a fourth column. When the original matrix is compressed in the CSC format, pointers and indices for respective values are determined. The CSC format is composed of three components: a value of a non-zero element; an index indicating a row number for each value; and a pointer obtained by accumulating and adding values of non-zero elements in each column. The CSR format is composed of a value of a non-zero element, an index indicating a column number for each value, and a pointer obtained by accumulating and adding values of non-zero elements in each row.

The pointer buffer 110 temporarily stores a pointer among the compressed sparse matrix data. The pointer may be extracted from the compressed sparse matrix data stored in the global buffer 400. As described above, the pointer in the CSC format is a value obtained by accumulating and adding the number of values of non-zero values in each column, and the pointer in the CSR format is a value obtained by accumulating and adding the number of values of of non-zero values in each row.

The non-zero buffer 120 stores a value of a non-zero element among the compressed sparse matrix data along with an index indicating the location of a row or column where the value of the non-zero element is located. The index in the CSC format indicates the location of a row where the value of the non-zero element is located, and the index in the CSR format indicates the location of a column where the value of the non-zero element is located.

The element selection unit 130 selects necessary data from the non-zero buffer 120 based on the pointer stored in the pointer buffer 110 by using a relative index to be described later. The dense mapping unit 140 performs decompression by locating non-zero data at a location corresponding to the index where the data selected by the element selection unit 130 is stored, and sequentially stores the data in the dense format buffer 150.

The dense format buffer 150 temporarily stores the decompressed data until the amount of decompressed data reaches the amount required for one operation of the overall array of the PEs 310 of the computation unit 300, and then transfers the data to the computation unit 300. In the illustrated example of the original matrix, a, b, c, d, e, f, and g represent values

of non-zero elements, respectively. Also, row numbers for the respective values are recorded in first (0) to fourth (3) rows. That is, indices for a, c, and g may be recorded as 0, an index for d may be recorded as 1, indices for b and f may be recorded as 2, and an index for e may be recorded as 3. Then, an initial pointer value is set to 0, and the number of values of non-zero elements in each column is accumulated and recorded. That is, after the initial value is recorded as 0, the number of values of non-zero elements in a first column may be accumulated by 2 and recorded as 2, the number of values of non-zero elements in a second column may be accumulated by 3 and recorded as 5, the number of values of non-zero elements in a third column may be accumulated by 1 and recorded as 6, and the number of values of non-zero elements in a fourth column may be accumulated by 1 and recorded as 7. As described above, the CSC format data may be generated for the original matrix. Such compressed data may be transferred to the decompression unit 100 via the global buffer 400 and then decompressed in the decompression unit 100.

First, the decompression unit 100 obtains a value corresponding to a pointer from the compressed data and stores the value in the pointer buffer 110 (S110). The decompression unit 100 receives a value corresponding to a pointer from the CSC format data stored in the global buffer 400 and stores the value in the pointer buffer 110.

Then, the decompression unit 100 obtains a relative index based on the values stored in the pointer buffer 110. The decompression unit 100 sequentially performs subtraction on adjacent values among the values stored in the pointer buffer 110 and sets a difference between the values as a relative index (S120). Referring to the illustrated example, a difference 2 between a first pointer 0 stored at the very front and a second pointer 2 is calculated as a relative index, a difference 3 between the second pointer 2 and a third pointer 5 is calculated as a relative index, and a difference 1 between the third pointer 5 and a fourth pointer 6 is calculated as a relative index.

Thereafter, the decompression unit 100 receives an index and a value of a non-zero element from the CSC format data stored in the global buffer 400 and matches and stores them in the non-zero buffer 120 (S120). That is, the value of the non-zero element and the index indicating the row number for the value are stored together in an individual buffer of the non-zero buffer 120. In this way, a non-zero element is defined as including the value of the non-zero element and the index information for the value. That is, the non-zero element, which has been stored in the non-zero buffer 120, retains a state where the value of the non-zero element is matched and stored with the index information for the value. As shown in the drawings, each of a non-zero element 0/a where a first value a among the values stored in the global buffer 400 and its index 0 are matched and a non-zero element 2/b where a second value b and its index 2 are matched is stored in the non-zero buffer 120. Herein, the index in the CSC format indicates a row number for the value of the non-zero element, and the index in the CSR format indicates a column number for the value of the non-zero element.

Then, in order of the previously calculated relative indices, non-zero elements corresponding in number to the value of each relative index are selected from among the non-zero elements stored in the non-zero buffer 120 and sequentially stored in the dense mapping unit 140 (S130). As shown in the drawings, two non-zero elements 0/a and 2/b are sequentially selected from among the values stored in the non-zero buffer 120 according to a first relative index, i.e., 2, and then stored in the dense mapping unit 140. Thereafter, next three non-zero elements 0/c, 1/d and 3/e may be sequentially selected according to a second relative index, i.e., 3, and then stored in the dense mapping unit 140.

Then, the dense mapping unit 140 stores the values of the non-zero elements in the dense format buffer 150 based on the non-zero elements received in the previous process (S140). First, all values are initialized to 0 and recorded in the dense format buffer 150. Thereafter, the values of the non-zero elements are stored in the dense format buffer 150 at addresses corresponding to their indices based on information of the non-zero elements selected in the previous process. For example, the value a of the non-zero element among information of the first non-zero element 0/a may be stored in a first buffer of the dense format buffer 150. Also, the value b of the non-zero element among information of the second non-zero element 2/b may be stored in a third buffer of the dense format buffer 150, at an address offset by the index 2. Through this process, an example of the dense format buffer 150 with the recorded values of the non-zero elements can be seen from a diagram of a next process (S150). This state corresponds to the state of the data stored in the first column of the original matrix, which confirms that the CSC format data has been decompressed and restored to be the same as the original matrix.

Then, the values recorded in the dense format buffer 150 are transferred to the PE array of the computation unit 300 for each cycle (S150). When the values recorded in the dense format buffer 150 reach a predetermined amount, the corresponding data is output to each PE. In this case, as shown in the drawings, values a, 0, b and 0 output by individual buffer units constituting the dense format buffer 150 may be transferred to the respective PEs 310.

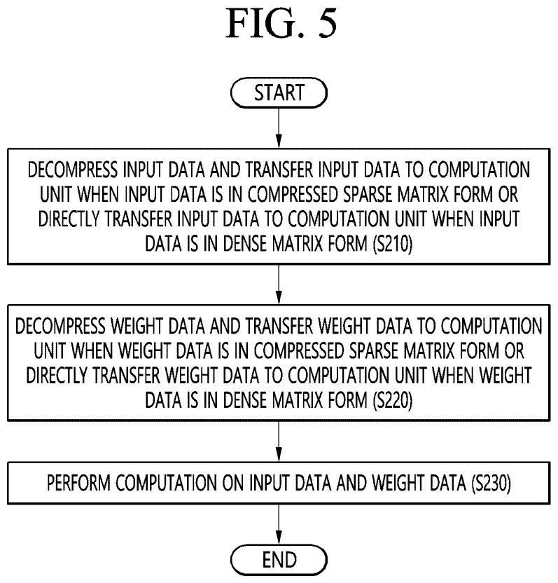

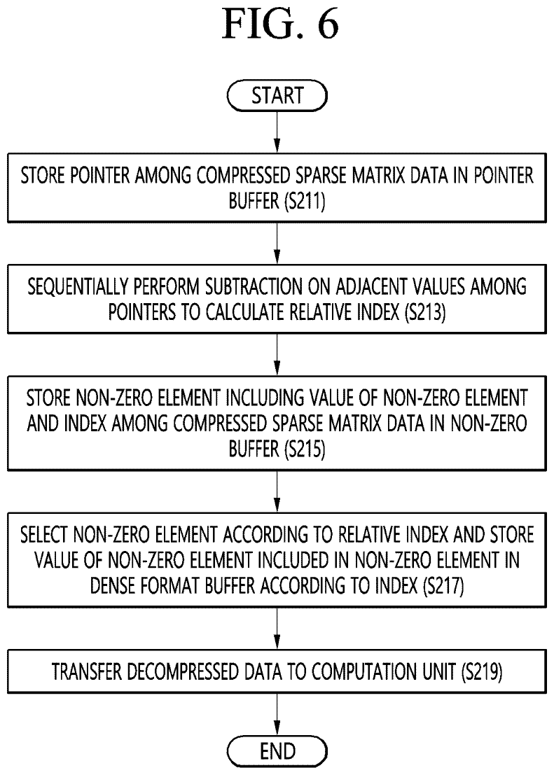

FIG. 5 is a flowchart showing an operation method of the computation accelerator according to an embodiment of the present disclosure, and FIG. 6 is a flowchart showing a decompression method of the computation accelerator according to an embodiment of the present disclosure.

When input data output by the global buffer 400 is in the form of a compressed sparse matrix, the input data is decompressed by the first decompression unit 100 and then transferred to the computation unit 300, or when the input data is in the form of a dense matrix, it is directly transferred to the computation unit 300 (S210).

Also, when weight data output by the global buffer 400 is in the form of a compressed sparse matrix, the weight data is decompressed by the second decompression unit 200 and then transferred to the computation unit 300, or when the weight data is in the form of a dense matrix, it is directly transferred to the computation unit 300 (S220). The processes S210 and S220 may be performed simultaneously, or either process may be performed first. For example, the weight data and the input data may be transferred together to the computation unit 300, or the weight data may be transferred first, followed by the input data, or vice versa.

Then, the computation unit 300 performs computation on the input data received in the form of the dense matrix from the global buffer 400 or the input data decompressed in the form of the dense matrix by the first decompression unit 100 and the weight data received in the form of the dense matrix from the global buffer 400 or the weight data decompressed in the form of the dense matrix by the second decompression unit 200 (S230).

A decompression process of each decompression unit 100 or 200 illustrated in FIG. 6 will be described below.

First, the pointer buffer 110 temporarily stores a pointer among the compressed sparse matrix data (S211).

Then, a difference between pointer values calculated by sequentially performing subtraction on adjacent values among the pointers stored in the pointer buffer 110 is set as a relative index (S213).

Thereafter, a non-zero element including a value of the non-zero element and an index among the compressed sparse matrix data is stored in the non-zero buffer 120 (S215). In this case, only a part of the non-zero element may be stored in the non-zero buffer 120.

In order of the relative indices, non-zero elements corresponding in number to the value of each relative index are selected from among the non-zero elements stored in the non-zero buffer 120, and values of the non-zero elements included in the selected non-zero elements are stored in the dense format buffer 150 according to the indices matched and stored with the values (S217). When a predetermined number of non-zero elements are recorded in the dense format buffer 150, the process S217 of selecting additional non-zero elements from the non-zero buffer 120 and storing them in the dense format buffer 150 may be performed repeatedly as in the process S215.

When the amount of decompressed data stored in the dense format buffer 150 reaches a predetermined amount, the decompressed data is transferred to the computation unit 300 (S219).

According to the present disclosure, a processing unit having a simple structure designed to process dense matrix data is used to perform dense matrix multiplication on compressed matrix data. In particular, a global buffer only needs to store necessary data in a compression format, and, thus, it is possible to reduce the energy consumed for data storage in the global buffer. That is, according to the present disclosure, the decompression unit 100 is inserted between the global buffer 400 and the PE 310 and the global buffer 400 only needs to store necessary data in a compression format, which causes a reduction in energy consumed for data storage. Further, a computation unit is configured with the processing unit having a simple structure designed to process dense matrix data, and, thus, it is possible to reduce the area required to design an accelerator.

Furthermore, the accelerator processes data in a predetermined order and thus does not require devices for index matching. Therefore, it is possible to reduce the additionally required area and the energy required to perform computation.

Also, according to the present disclosure, a decompression unit is provided to use data receives in various compression formats from external sources. Therefore, it is possible to reduce required storage capacity and energy for data communication and data storage.

In AI processing, matrices are typically divided into smaller tiled matrices for processing. According to the compression method of the present disclosure, more tiles can be stored in the same capacity memory, which enables more computations with a single tile. When the amount of uncompressed data exceeds the storage capacity of the accelerator, the data may be transmitted several times, which may cause an increase in data communication overhead. This can be mitigated by applying the compression method.

Also, according to the present disclosure, AI computations regardless of whether or not data is compressed can be performed by variously using the devices. Real-world sparse neural networks vary in sparsity depending on their layers and input data. When data is relatively dense, using a compression format may require more storage capacity than storing the data including zeros. Even in this case, sparse neural network accelerators store and process data in compression formats, which leads to unnecessary energy consumption in memories and index matching devices. However, according to the present disclosure, data is stored in the form of an uncompressed dense matrix and bypasses the decompression unit and thus can be processed as in a dense matrix multiplication accelerator.

Moreover, according to the present disclosure, it is possible to adapt to processing of new neural network models. Conventional sparse neural networks are typically created by performing additional processing on general dense neural networks. In the additional processing, the neural networks require respective optimization strategies and parameters, which necessitate time to determine these values. This implies that latest neural network models cannot be processed directly by sparse neural network accelerators. However, according to the present disclosure, it is possible to operate a general dense matrix multiplication accelerator to process a latest neural network model without a developed sparse neural network, which makes it compatible with latest learning models of AI accelerators.

The method according to an embodiment of the present disclosure can be embodied in a storage medium including instruction codes executable by a computer such as a program module executed by the computer. A computer-readable medium can be any usable medium which can be accessed by the computer and includes all volatile/non-volatile and removable/non-removable media. Further, the computer-readable medium may include all computer storage media. The computer storage media include all volatile/non-volatile and removable/non-removable media embodied by a certain method or technology for storing information such as computer-readable instruction code, a data structure, a program module or other data.

The method and system of the present disclosure have been explained in relation to a specific embodiment, but their components or a part or all of their operations can be embodied by using a computer system having general-purpose hardware architecture.

The above description of the present disclosure is provided for the purpose of illustration, and it would be understood by a person with ordinary skill in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A computation accelerator, comprising:
a global buffer that temporarily stores first data or second data in the form of a dense matrix or in the form of a compressed sparse matrix;
a first decompression unit that decompresses the first data when the first data output by the global buffer is in the form of the compressed sparse matrix;
a second decompression unit that decompresses the second data when the second data output by the global buffer is in the form of the compressed sparse matrix; and
a computation unit that performs computation on the first data received in the form of the dense matrix from the global buffer or the first data decompressed in the form of the dense matrix by the first decompression unit and the second data received in the form of the dense matrix from the global buffer or the second data decompressed in the form of the dense matrix by the second decompression unit.

2. The computation accelerator of claim 1,
wherein the first data is input data, and the second data is weight data.

3. The computation accelerator of claim 1, further comprising:
a first multiplexer (MUX) that selectively transfers either an output of the global buffer or an output of the first decompression unit to the computation unit; and
a second MUX that selectively transfers either an output of the global buffer or an output of the second decompression unit to the computation unit.

4. The computation accelerator of claim 3,
wherein the first MUX selects the output of the global buffer and outputs the selected output to the computation unit when the first data is in the form of the dense matrix, and selects the output of the first decompression unit and outputs the selected output to the computation unit when the first data is in the form of the compressed sparse matrix, and
the second MUX selects the output of the global buffer and outputs the selected output to the computation unit when the second data is in the form of the dense matrix, and selects the output of the second decompression unit and outputs the selected output to the computation unit when the second data is in the form of the compressed sparse matrix.

5. The computation accelerator of claim 1,
wherein the data in the form of the compressed sparse matrix is compressed in a CSC (Compressed Sparse Column) or CSR (Compressed Sparse Row) format, and
when the data in the form of the compressed sparse matrix is compressed in the CSC format,
it is composed of a value of a non-zero element, an index indicating a row number for the value of the non-zero element, and a pointer obtained by accumulating and adding values of non-zero elements in each column, and
when the data in the form of the compressed sparse matrix is compressed in the CSR format,
it is composed of a value of a non-zero element, an index indicating a column number for the value of the non-zero element, and a pointer obtained by accumulating and adding values of non-zero elements in each row.

6. The computation accelerator of claim 5,
wherein the first decompression unit or the second decompression unit includes a pointer buffer, a non-zero buffer, and a dense format buffer, and
the pointer buffer temporarily stores the pointer among the data in the form of the compressed sparse matrix,
the non-zero buffer stores a non-zero element including the value of the non-zero element and the index among the data in the form of the compressed sparse matrix,
the first decompression unit or the second decompression unit sequentially performs subtraction on adjacent values among the pointers stored in the pointer buffer and sets a difference between the pointer values as a relative index, and
non-zero elements corresponding in number to the value of each relative index are selected from among the non-zero elements stored in the non-zero buffer in order of the relative indices, and values of the non-zero elements included in the selected non-zero elements are stored in the dense format buffer according to the indices matched and stored with the values.

7. The computation accelerator of claim 6,
wherein the first decompression unit or the second decompression unit transfers the decompressed data to the computation unit when the amount of the decompressed data stored in the dense format buffer reaches a predetermined amount.

8. A operation method of a computation accelerator, comprising:
a process (a) of decompressing first data by a first decompression unit and then transferring the decompressed first data to a computation unit when the first data output by a global buffer is in the form of a compressed sparse matrix, or transferring the first data to the computation unit when the first data is in the form of a dense matrix;
a process (b) of decompressing second data by a second decompression unit and then transferring the decompressed second data to the computation unit when the second data output by the global buffer is in the form of the compressed sparse matrix, or transferring the second data to the computation unit when the second data is in the form of the dense matrix; and
a process (c) of performing computation on the first data received in the form of the dense matrix from the global buffer or the first data decompressed in the form of the dense matrix by the first decompression unit and the second data received in the form of the dense matrix from the global buffer or the second data decompressed in the form of the dense matrix by the second decompression unit.

9. The operation method of a computation accelerator of claim 8,
wherein the first data is input data, and the second data is weight data.

10. The operation method of a computation accelerator of claim 8,
wherein in the process (a),
a first multiplexer (MUX) connected to the global buffer and the first decompression unit selects and outputs an output of the global buffer when the first data is in the form of the dense matrix, and selects and outputs an output of the first decompression unit when the first data is in the form of the compressed sparse matrix, and
in the process (b),
a second MUX connected to the global buffer and the second decompression unit selects and outputs an output of the global buffer when the second data is in the form of the dense matrix, and selects and outputs an output of the second decompression unit when the second data is in the form of the compressed sparse matrix.

11. The operation method of a computation accelerator of claim 8,
wherein the data in the form of the compressed sparse matrix is compressed in a CSC (Compressed Sparse Column) or CSR (Compressed Sparse Row) format, and
when the data in the form of the compressed sparse matrix is compressed in the CSC format,
it is composed of a value of a non-zero element, an index indicating a row number for the value of the non-zero element, and a pointer obtained by accumulating and adding values of non-zero elements in each column, and
when the data in the form of the compressed sparse matrix is compressed in the CSR format,
it is composed of a value of a non-zero element, an index indicating a column number for the value of the non-zero element, and a pointer obtained by accumulating and adding values of non-zero elements in each row.

12. The operation method of a computation accelerator of claim 11,
wherein the process (a) of decomposing the first data by the first decompression unit includes:
a process of temporarily storing the pointer among the data in the form of the compressed sparse matrix in a pointer buffer;
a process of sequentially performing subtraction on adjacent values among the pointers stored in the pointer buffer and setting a difference between the pointer values as a relative index;
a process of storing a non-zero element including the value of the non-zero element and the index among the data in the form of the compressed sparse matrix in a non-zero buffer;
a process of selecting non-zero elements corresponding in number to the value of each relative index from among the non-zero elements stored in the non-zero buffer in order of the relative indices, and storing values of the non-zero elements included in the selected non-zero elements in the dense format buffer according to the indices matched and stored with the values; and
a process of transferring the decompressed data to the computation unit when the amount of the decompressed data stored in the dense format buffer reaches a predetermined amount.

13. The operation method of a computation accelerator of claim 11,
wherein the process (b) of decomposing the second data by the second decompression unit includes:
a process of temporarily storing the pointer among the data in the form of the compressed sparse matrix in a pointer buffer;
a process of storing a non-zero element including the value of the non-zero element and the index among the data in the form of the compressed sparse matrix in a non-zero buffer;
a process of sequentially performing subtraction on adjacent values among the pointers stored in the pointer buffer and setting a difference between the pointer values as a relative index;
a process of selecting non-zero elements corresponding in number to the value of each relative index from among the non-zero elements stored in the non-zero buffer in order of the relative indices, and storing values of the non-zero elements included in the selected non-zero elements in the dense format buffer according to the indices matched and stored with the values; and
a process of transferring the decompressed data to the computation unit when the amount of the decompressed data stored in the dense format buffer reaches a predetermined amount.

14. A non-transitory recording medium having, recorded thereon, a computer program for executing an operation method of a computation accelerator of claim 8.
